(19) United States
(12) Patent Application Publication
(10) Pub. No.: US 2026/0333219 A1
(43) Pub. Date: Oct. 22, 2026

(54) MANAGING PEER-TO-PEER GROUPS

(71) Applicant: QUALCOMM Incorporated, San Diego, CA (US)

(72) Inventors: George CHERIAN, San Diego, CA (US); Abhishek Pramod PATIL, San Diego, CA (US); Alfred ASTERJADHI, San Diego, CA (US); Giovanni CHISCI, San Diego, CA (US); Naveen Kumar KAKANI, Flower Mound, TX (US); Andrew MacKinnon DAVIDSON, Monte Sereno, CA (US); Rolf DE VEGT, San Francisco, CA (US)

(21) Appl. No.: 19/653,026

(22) Filed: Apr. 20, 2026

Related U.S. Application Data
(60) Provisional application No. 63/792,893, filed on Apr. 22, 2025.

(51) Int. Cl. H04W 52/02

(52) U.S. Cl. CPC H04W 52/0216

(57) ABSTRACT

This disclosure provides methods, components, devices and systems for managing peer-to-peer (P2P) groups. In some examples, one or more stations (STAs) may request a restricted target wakeup time (rTWT) service period (SP) during which one or more STAs may contend for access to a wireless channel with reduced risk of contention with other STAs that are not part of the P2P group. One or more associated clients may request rTWT schedule setup from an access point (AP). If multiple clients request to setup or join the same schedule, then the AP may allocated overlapping rTWT service periods. The AP may broadcast an indication of the rTWT schedule, such that other STAs may end respective TXOPs prior to the beginning of the rTWT SP. During the rTWT SP, the STAs that have requested the rTWT SP may perform group P2P communications.

### CROSS REFERENCE

The present Application for Patent claims the benefit of U.S. Provisional Patent Application No. 63/792,893 by CHERIAN et al., entitled “MANAGING PEER-TO-PEER GROUPS,” filed Apr. 22, 2025, assigned to the assignee hereof, and expressly incorporated herein.

### TECHNICAL FIELD

This disclosure relates generally to wireless communication and, more specifically, to managing peer-to-peer (P2P) groups.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

An innovative aspect of the subject matter described in this disclosure can be implemented in a method. The method may include transmitting a setup frame including a request for a restricted target wakeup time (rTWT) service period (SP) for peer-to-peer (P2P) communications with one or more sets of STAs including the STA, receiving a message from an access point (AP) indicating a schedule for the rTWT SP corresponding to the one or more sets of STAs, and performing group P2P communications with one or more STAs of the one or more sets of STAs during the rTWT SP in accordance with the schedule.

Another innovative aspect of the subject matter described in this disclosure can be implemented in a STA. The STA may include a processing system that includes processor circuitry and memory circuitry that stores code. The processing system may be configured to cause the STA to transmit a setup frame including a request for a restricted target wakeup time (rTWT) service period (SP) for peer-to-peer (P2P) communications with one or more sets of STAs including the STA, receive a message from an AP indicating a schedule for the rTWT SP corresponding to the one or more sets of STAs, and perform group P2P communications with one or more STAs of the one or more sets of STAs during the rTWT SP in accordance with the schedule.

Another innovative aspect of the subject matter described in this disclosure can be implemented in a STA. The STA may include means for transmitting a setup frame including a request for a restricted target wakeup time (rTWT) service period (SP) for peer-to-peer (P2P) communications with one or more sets of STAs including the STA, means for receiving a message from an AP indicating a schedule for the rTWT SP corresponding to the one or more sets of STAs, and means for performing group P2P communications with one or more STAs of the one or more sets of STAs during the rTWT SP in accordance with the schedule.

Another innovative aspect of the subject matter described in this disclosure can be implemented in a non-transitory computer-readable medium storing code for wireless communications is described. The code may include instructions executable by one or more processors to transmit a setup frame including a request for a restricted target wakeup time (rTWT) service period (SP) for peer-to-peer (P2P) communications with one or more sets of STAs including the STA, receive a message from an AP indicating a schedule for the rTWT SP corresponding to the one or more sets of STAs, and perform group P2P communications with one or more STAs of the one or more sets of STAs during the rTWT SP in accordance with the schedule.

Some examples of the method, STAs, and non-transitory computer-readable medium described herein may further include operations, features, means, or instructions for including, in the setup frame, an indication that the request may be for the group P2P communications.

In some examples of the method, stations (STAs), and non-transitory computer-readable medium described herein, the indication includes a field in the setup frame, the field indicating a type of TWT corresponding to the rTWT SP for P2P communications.

In some examples of the method, stations (STAs), and non-transitory computer-readable medium described herein, the indication includes a field in an information extension element indicating a type of TWT corresponding to the rTWT SP for P2P communications.

In some examples of the method, stations (STAs), and non-transitory computer-readable medium described herein, the indication includes a recommendation field of an information element, the recommendation field including a value corresponding to the rTWT SP for P2P communications.

In some examples of the method, stations (STAs), and non-transitory computer-readable medium described herein, the indication includes a bitmap of a traffic information control field of a TWT information element, the bitmap indicating the requested rTWT SP for P2P communications.

In some examples of the method, stations (STAs), and non-transitory computer-readable medium described herein, the setup frame includes a request to join an existing schedule, create a new schedule, or update an existing schedule.

Some examples of the method, stations (STAs), and non-transitory computer-readable medium described herein may further include operations, features, means, or instructions for transmitting a second setup frame including a request to tear down the schedule for the rTWT SP corresponding to the one or more sets of STAs and receiving a responsive message confirming tear down of the schedule based on the request to tear down the schedule.

In some examples of the method, stations (STAs), and non-transitory computer-readable medium described herein, the message includes a TWT element carried by a beacon message, the TWT element including one or more restricted TWT parameter sets including at least one restricted TWT parameter set corresponding to the P2P communications, the beacon message further including an indication that the one or more restricted TWT parameter sets correspond to the group P2P communications.

In some examples of the method, stations (STAs), and non-transitory computer-readable medium described herein, the indication includes a value of a broadcast TWT recommendation field within the one or more restricted TWT parameter sets that corresponds to the group P2P communications.

In some examples of the method, stations (STAs), and non-transitory computer-readable medium described herein, the indication includes one or more TWT identifiers carried within an information extension element carried by the beacon message, each of the one or more TWT identifiers corresponding to an rTWT schedule for P2P communications.

Some examples of the method, stations (STAs), and non-transitory computer-readable medium described herein may further include operations, features, means, or instructions for generating a group identifier for the one or more sets of STAs and including the group identifier in the request for the rTWT SP, where the message includes the group identifier indicating that the rTWT SP may be exclusive to the one or more sets of STAs.

In some examples of the method, stations (STAs), and non-transitory computer-readable medium described herein, the group identifier may be carried within a TWT information extension element carried within a beacon frame.

Some examples of the method, stations (STAs), and non-transitory computer-readable medium described herein may further include operations, features, means, or instructions for including, in the request, the group identifier, the setup frame including a traffic information field, the group identifier indicating the schedule that the STA may be requesting to join, extend, or teardown.

Some examples of the method, stations (STAs), and non-transitory computer-readable medium described herein may further include operations, features, means, or instructions for receiving, during the rTWT SP based on receiving the message, a control frame which reserves at least a portion of the rTWT SP for the one or more sets of STAs and excludes one or more additional STAs from communications during the rTWT SP and initiating the group P2P communications with one or more STAs of the one or more sets of STAs based on receiving the control frame.

In some examples of the method, stations (STAs), and non-transitory computer-readable medium described herein, the control frame includes a clear-to-send (CTS) self message setting a network allocation vector (NAV) for the one or more additional STAs.

In some examples of the method, stations (STAs), and non-transitory computer-readable medium described herein, the control frame includes a media access control (MAC) address allocated for group P2P communications, the MAC address being based on a group identifier corresponding to the one or more sets of STAs.

Some examples of the method, stations (STAs), and non-transitory computer-readable medium described herein may further include operations, features, means, or instructions for including, in the setup frame, an indication of one or more quality of service parameters corresponding to the STA, where receiving the message may be based on the one or more quality of service parameters satisfying a threshold.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example physical layer (PHY) protocol data unit (PPDU) usable for communications between a wireless AP and one or more wireless STAs.

FIG. 3 shows a hierarchical format of an example PPDU usable for communications between a wireless AP and one or more wireless STAs.

FIG. 4 shows a pictorial diagram of another example wireless communication network.

FIG. 5 shows an example of a signaling diagram that supports managing peer-to-peer (P2P) groups.

FIG. 6 shows an example of a signaling diagram that supports managing P2P groups.

FIG. 7 shows an example of a process flow that supports managing P2P groups.

FIG. 8 shows a block diagram of an example wireless communication device that supports managing P2P groups.

FIGS. 9 through 11 show flowcharts illustrating example processes performable by or at a STA that supports managing P2P groups.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, one or more stations (STAs) may perform group P2P communications. However, if STAs of a group of P2P STAs fail to access a wireless channel or coordinate communication effectively, the P2P communications may fail. In some examples, a wireless communications system may support frequency domain P2P management (for example, P2P communications may be allocated to a dedicated channel), or may support time domain P2P management (e.g., P2P transmission opportunities (TXOPs) are allocated for P2P communications). However, such P2P management systems may be inefficient. For example, if an entire channel, or an entire TXOP, is allocated for P2P communications, and thee group of P2P devices does not have much, or any, traffic to communicate the channel, to the TXOP, may remain unutilized (which may result in inefficient use of available system resources, decreased throughput, increased system latency, and poor user experience).

Various aspects relate generally to managing P2P communications. Some aspects more specifically relate to signaling and resource usage to support effective and efficient use of available system resources for group P2P communications. In some examples, one or more STAs may request a restricted target wakeup time (rTWT) service period (SP) during which one or more STAs may contend for access to a wireless channel with reduced (such as, avoided or mitigated) risk of contention with other STAs that are not part of the P2P group. For example, one or more associated clients may request rTWT schedule setup from an access point (AP). If multiple clients request to setup or join the same schedule, then the AP may allocated overlapping rTWT service periods. The AP may allocate the rTWT schedule. The AP may broadcast an indication of the rTWT schedule, such that other STAs may end respective TXOPs prior to the beginning of the rTWT SP. Neighboring APs may also announce the schedule to respective basic service sets (BSSs) so that other STAs will also avoid transmission during the rTWT SP. During the rTWT SP, the STAs that have requested the rTWT SP may perform group P2P communications. Each STA of the group may contend for access to the channel, and may have a higher likelihood of gaining access for P2P communications due to the lack of other devices (such as, outside of the group of STAs) attempting to access the channel during the rTWT SP.

Particular aspects of the subject matter described in this disclosure can be implemented to realize one or more of the following potential advantages. In some examples, by setting up the rTWT schedule as requested by the various STAs of the group of STAs, the described techniques can be used to more efficiently utilize available system resources, improve access to a wireless medium by P2P devices, improve throughput, decrease interference, increase the reliability of wireless communications for P2P devices, and improve user experience.

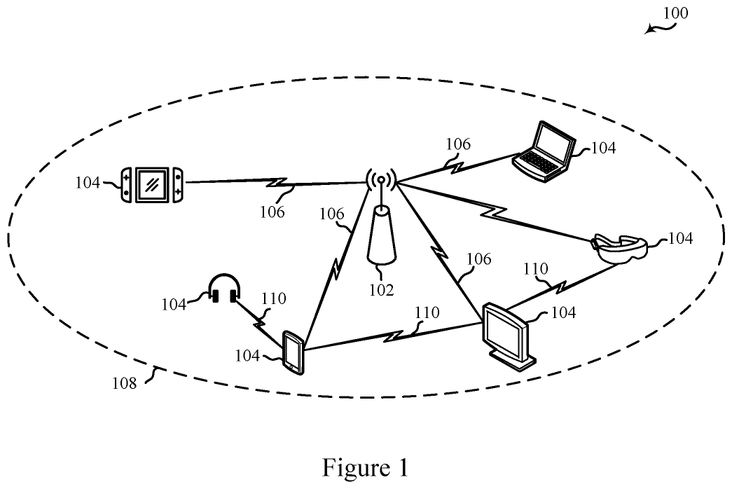

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR-or IEEE 802.11bn-compatible) devices for opportunistic access to spectrum that may be otherwise under-utilized.

Puncturing is a wireless communication technique that enables a wireless communication device (such as either an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as an AP 102 or a STA 104) may puncture the subchannels on which there is interference and in essence spread the data of the PPDU to cover the remaining portion of the bandwidth of the channel. For example, if a transmitting device determines (for example, detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while a UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

In some wireless communication systems, wireless communication devices (such as an AP 102 and STAs 104 described with reference to FIG. 1) may operate via one or more wireless communication links in a frequency band higher than a sub-7 GHz (sub 7, such as a 2.4 GHz frequency band, a 5 GHz frequency band, or a 6 GHz frequency band) frequency band. In some such wireless communication systems, the AP 102 and STAs 104 may communicate on a wireless communication link in a millimeter wave (“mmWave” or “mmW”) band (for example, a frequency band between 30 GHz and 300 GHz, such as a 60 GHz frequency band). A wireless communication system supporting such mmWave communications (such as AP 102 and STAs 104 in wireless communications network 100) may use integrated mmWave (IMMW) techniques to support operations in these frequency bands. To manage the relatively high attenuation losses and other path losses associated with the mmWave band, the AP 102 and STAs 104 may transmit and receive directional communications via beamforming procedures. To select or otherwise generate directional beams in the mmWave band, a wireless communication device may perform beam sweeping, searching and training operations, which may involve various training and feedback reporting packet sequences. In some wireless communication systems, a mmWave link supports data communications while a sub7 link may be used for management and control information signaling to support the mmWave communications. For example, a STA 104 may first associate with an AP 102 to establish a sub7 link, and thereafter, perform beam searching and training in the mmWave band to establish a mmWave link for the communication of data. In such examples, the sub7 link may be referred to as an anchor link.

In addition to beam searching and training procedures, an AP 102 and a STA 104, after having selected a beam pair, may perform beam management and recovery procedures, including periodic beacon-based procedures and aperiodic STA-initiated fast link recovery procedures, which may involve the use of beam recovery sequences. The AP 102 and STAs 104 may use these beam management and recovery procedures for beam sync-up and identifying broken links. When communicating via a mmWave link, the AP 102 and STAs 104 may perform various channel access procedures including contention-based access procedures, target wake time (TWT)-based access procedures (including the use of dedicated and opportunistic service periods (SPs)), scheduled-mode access procedures, and triggered-mode access procedures. The APs 102 and STAs 104 operating in the mmWave band also may support various management frame optimizations and procedures including optimizations and procedures associated with discovery, scanning, association, roaming, link setup, updates and maintenance, and the initial and continuing configuration of BSS and link-specific parameters including channel selection and rate adaptation. To support or facilitate communication in the mmWave band, the APs 102 and STAs 104 also may make use of various PHY layer enhancements, such as additional bandwidth modes, numerologies, tone plans, preamble designs, codebook designs, waveform designs, new PPDU formats or reuse of existing sub-7 GHz PPDU formats for mmWave frequencies. Particular RF and analog designs, such as RF front end designs, antenna integration designs, and conversion architecture designs, may be implemented in APs 102 and STAs 104 to support mmWave operation.

Transmitting and receiving devices AP 102 and STA 104 may support the use of various modulation and coding schemes (MCSs) to transmit and receive data in the wireless communication network 100 so as to optimally take advantage of wireless channel conditions, for example, to increase throughput, reduce latency, or enforce various quality of service (QoS) parameters. For example, existing technology (such as IEEE 802.11ax standard amendment protocols) supports the use of up to 1024-quadrature amplitude modulation (QAM), where a modulated symbol carries 10 bits. To further improve peak data rate, each of the AP 102 or the STA 104 may employ use of 4096-QAM (also referred to as “4k QAM”), which enables a modulated symbol to carry 12 bits. 4k QAM may enable massive peak throughput with a maximum theoretical PHY rate of 10 bps/Hz/subcarrier/spatial stream, which translates to 23 Gbps with 5/6 LDPC code (10 bps/Hz/subcarrier/spatial stream*996*4 subcarriers*8 spatial streams/13.6 μs per OFDM symbol). The AP 102 or the STA 104 using 4096-QAM may enable a 20% increase in data rate compared to 1024-QAM given the same coding rate, thereby allowing users to obtain higher transmission efficiency.

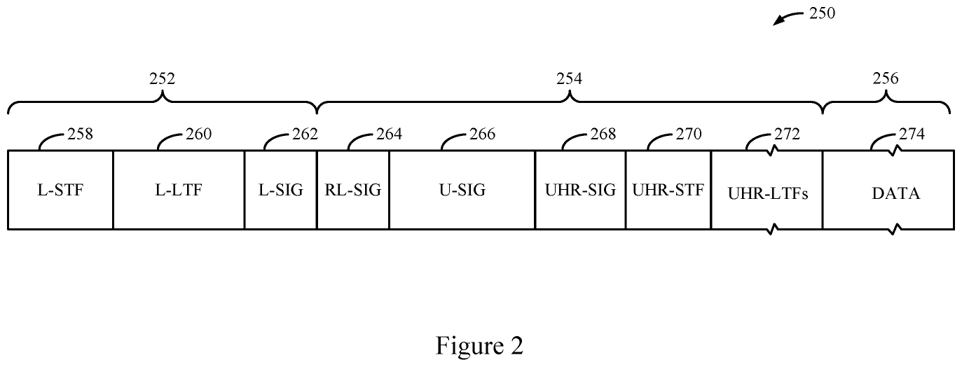

FIG. 2 shows an example physical layer (PHY) protocol data unit (PPDU) 250 usable for communications between a wireless AP and one or more wireless STAs. For example, the AP and STAs may be examples of the AP 102 and the STAs 104 described with reference to FIG. 1. As shown, the PPDU 250 includes a PHY preamble, that includes a legacy portion 252 and a non-legacy portion 254, and a payload 256 that includes a data field 274. The legacy portion 252 of the preamble includes an L-STF 258, an L-LTF 260, and an L-SIG 262. The non-legacy portion 254 of the preamble includes a repetition of L-SIG (RL-SIG) 264, a universal signal field 266 (referred to herein as “U-SIG 266”) and a UHR signal field 268 (referred to herein as “UHR-SIG 268”). The presence of RL-SIG 264 and U-SIG 266 may indicate to UHR or later version-compliant STAs 104 that the PPDU 250 is a UHR PPDU or a PPDU conforming to any later (post-UHR) version of a new wireless communication protocol conforming to a future IEEE 802.11 wireless communication protocol standard. One or both of U-SIG 266 and UHR-SIG 268 may be structured as, and carry version-dependent information for, other wireless communication protocol versions associated with amendments to the IEEE family of standards beyond UHR. For example, U-SIG 266 may be used by a receiving device (such as an AP 102 or a STA 104) to interpret bits in one or more of UHR-SIG 268 or the data field 274. U-SIG 266 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 266 and UHR-SIG 268 and additional information fields or single user (SU)-specific fields that may be useful to intended recipients. In some implementations, the version-dependent fields may include at least a PPDU format field to indicate a general PPDU format for the PPDU 250 (such as a trigger-based (TB), a single-user (SU), or a multi-user (MU) PPDU format). Like L-STF 258, L-LTF 260, and L-SIG 262, the information in U-SIG 266 and UHR-SIG 268 may be duplicated and transmitted in each of the component 20 MHz channels in instances involving the use of a bonded channel.

The non-legacy portion 254 further includes an additional short training field 270 (referred to herein as “UHR-STF 270,” although it may be structured as, and carry version-dependent information for, other wireless communication protocol versions beyond UHR) and one or more additional long training fields 272 (referred to herein as “UHR-LTFs 272,” although they may be structured as, and carry version-dependent information for, other wireless communication protocol versions beyond UHR). UHR-STF 270 may be used for timing and frequency tracking and AGC, and UHR-LTF 272 may be used for more refined channel estimation.

UHR-SIG 268 may be used by an AP 102 to identify and inform one or multiple STAs 104 that the AP 102 has scheduled uplink (UL) or downlink (DL) resources for them. UHR-SIG 268 may be decoded by each compatible STA 104 served by the AP 102. UHR-SIG 268 also may generally be used by the receiving device to interpret bits in the data field 274. For example, UHR-SIG 268 may include resource unit (RU) allocation information, spatial stream configuration information, and per-user (for example, STA-specific) signaling information. Each UHR-SIG 268 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 274.

In some wireless communications systems, a STA 104 or an AP 102 may transmit the PPDU 250 over bandwidths larger than the 20 MHz, 40 MHz, 80 MHz, 160 MHz, and 320 MHz bandwidths supported by previous generations of IEEE-compliant wireless communication systems. For example, the PPDU 250 may support 480 MHz or 640 MHz bandwidth communications. By increasing the channel bandwidth of the PPDU 250 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 270, UHR-LTFs 272, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 266 of an ELR PPDU 250 may include a first indication (for example, a codepoint of a PHY version identifier subfield within a version-independent portion of the U-SIG 266 or a value of an ELR subfield within a version-dependent portion of the U-SIG 266) that the PPDU 250 is associated with an ELR format. The U-SIG 266 of an ELR PPDU 250 may include a second indication (for example, a STA identifier subfield within the version-dependent portion of the U-SIG 266) of an intended receiver of the PPDU. In some examples, an ELR PPDU 250 may include an ELR-signature (ELR-SIG) field that includes an uplink/downlink indicator subfield, a length subfield, a coding indicator subfield, and a modulation and coding scheme (MCS) subfield.

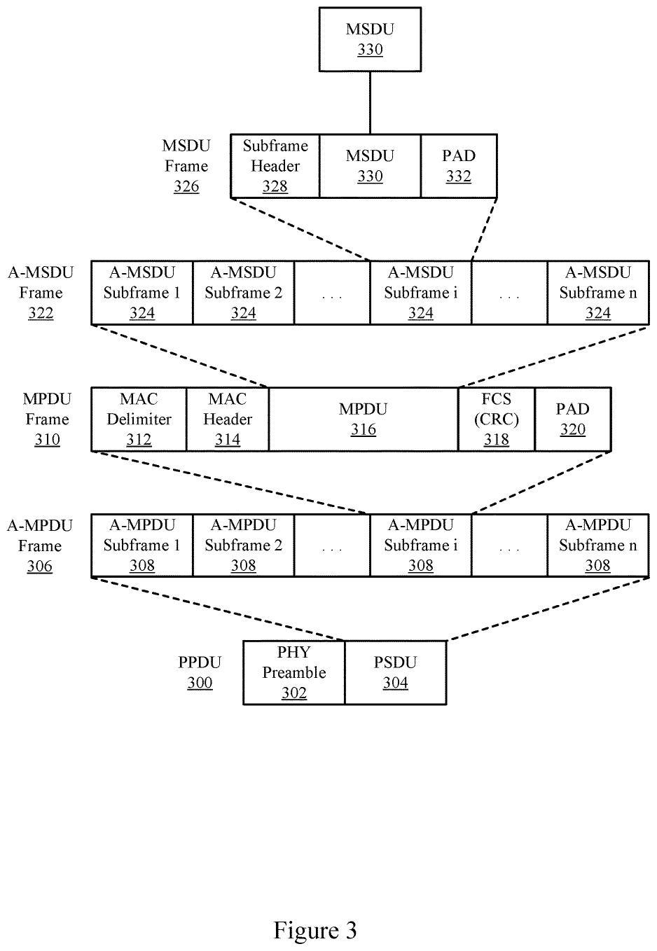

FIG. 3 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 308 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (for example, the FCS field 318 may include a cyclic redundancy check (CRC)) and padding bits 320. The MPDU 316 may carry one or more MAC service data units (MSDUs) 330. For example, the MPDU 316 may carry an aggregated MSDU (A-MSDU) 322 including multiple A-MSDU subframes 324. Each A-MSDU subframe 324 may be associated with an MSDU frame 326 and may contain a corresponding MSDU 330 preceded by a subframe header 328 and, in some examples, followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body. The MAC header 314 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 314 also includes one or more fields indicating addresses for the data encapsulated within the frame body. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (for example, identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (for example, identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (for example, the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (for example, the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (for example, the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

Retransmission protocols, such as hybrid automatic repeat request (HARQ), also may offer performance gains. A HARQ protocol may support various HARQ signaling between transmitting and receiving wireless communication devices (for example, the AP 102 and the STAs 104 described with reference to FIG. 1) as well as signaling between the PHY and MAC layers to improve the retransmission operations in a wireless communication network. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a wireless communication network may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (for example, a negative acknowledgment (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

APs and STAs (for example, the AP 102 and the STAs 104 described with reference to FIG. 1) that include multiple antennas may support various diversity schemes. For example, spatial diversity may be used by one or both of a transmitting device (such as an AP 102 or a STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally, or alternatively, involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (for example, in the form of a null data packet (NDP)) to the beamformee. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (for example, identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communications to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

In some implementations, the AP 102 and STAs 104 can support various multi-user communications; that is, concurrent transmissions from one device to each of multiple devices (for example, multiple simultaneous downlink communications from an AP 102 to corresponding STAs 104), or concurrent transmissions from multiple devices to a single device (for example, multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

In some wireless communications systems, an AP 102 may allocate or assign multiple RUs to a single STA 104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHz and 640 MHz), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment and the 802.11bn standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured. Accordingly, spectrum efficiency and flexibility may be increased.

As described previously, STA-specific RU allocation information may be included in a signaling field (such as the UHR-SIG field for a UHR PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some examples, the RU allocation information in the common field of UHR-SIG can be used to individually allocate RUs to the single user, thereby avoiding the punctured channels. In some other examples, U-SIG may be used to indicate SU preamble puncturing. For example, the SU preamble puncturing may be indicated by a value of the UHR-SIG compression field in U-SIG.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHz, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (for example, one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (for example, switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (for example, monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

A wireless communication device may include an auxiliary radio and a main radio and may operate in both an auxiliary radio mode and a main radio mode. The wireless communication device may be a STA or an AP, such as, for example, the AP 102 and STAs 104 described with reference to FIG. 1. Additionally, the wireless communication device may support communications over a single wireless link or over multiple wireless links. For example, the wireless communication device may be an AP MLD or a non-AP MLD. The auxiliary radio mode may support communications with relatively lower data rates (such as ≤24 Mbps) than the main radio mode. For example, while operating in an auxiliary radio mode, the auxiliary radio of the wireless communication device may transmit messages having a non-high throughput (non-HT) format whereas, while operating in a main radio mode, the main radio may transmit messages having an EHT, UHR or later protocol format. A wireless communication device that uses an auxiliary radio in addition to a main radio may improve reliability and reduce latency and power consumption. For example, the wireless communication device may improve reliability by using the auxiliary radio to transmit/receive redundancies, facilitate fast feedback exchanges, or otherwise increase robustness for high-priority or otherwise important packets (for example, packets containing latency-sensitive traffic or traffic requiring high reliability). For example, to support latency-sensitive traffic insertion in uplink communications, an AP may utilize its auxiliary radio for detection of low latency PPDU (LL-PPDU) subframes associated with latency-sensitive traffic. As another example, the wireless communication device also may use the auxiliary radio to scan for channels while communicating on another channel via the main radio, thereby reducing latency associated with a transition between channels by eliminating the time for the main radio to scan for channels. As another example, use of the auxiliary radio may reduce power consumption by enabling the main radio to enter a sleep mode and monitoring for wake-up signals via the auxiliary radio, which is designed to consume less power than the main radio.

The auxiliary radio may support both transmitting and receiving (Tx/Rx) modes of operation, or may support receiving-only (Rx-only) modes of operation. If the wireless communication device is an MLD, the wireless communication device may communicate on one or more wireless links using a main radio and may simultaneously communicate on one or more wireless links using one or more auxiliary radios. In an MLD scenario in which the auxiliary radio is Rx-only capable (an “Aux-Rx” mode), the wireless communication device may transmit and receive communications on a first wireless link using the main radio but may simultaneously receive (but not transmit) communications on a second wireless link using the auxiliary radio. In an MLD scenario in which the auxiliary radio is Tx/Rx capable (an “Aux-Tx/Rx” mode), the wireless communication device may transmit and receive communications on a first wireless link using the main radio and may simultaneously transmit and receive communications on a second wireless link using the auxiliary radio. In an MLD scenario, the wireless communication device may transition the main radio from a second wireless link to a first wireless link and may correspondingly transition the auxiliary radio from the first wireless link to the second wireless link. For example, the wireless communication device's auxiliary radio may receive control signaling on the second wireless link from another wireless communication device that triggers the wireless communication device to switch the use of its radios between wireless links. If the wireless communication device is not an MLD, the wireless communication device may transition from using its auxiliary radio to using its main radio mode on a single wireless link. For example, the wireless communication device's auxiliary radio may receive control signaling from another wireless communication device that triggers the wireless communication device to initiate the transition from use of the auxiliary radio to the main radio on the wireless link. Upon such a transition, the wireless communication device may place the auxiliary radio in a powered-down sleep state while activating the main radio to an awake state. Similarly, the wireless communication may transition from using its main radio to its auxiliary radio on the wireless link upon receiving a triggering control signal.

In some examples, the wireless communication device (such as a STA) may indicate (for example, via a broadcast frame such as a beacon frame or other management frame), to other wireless communication devices (such as an AP), parameters associated with an auxiliary radio mode or parameters associated with transitioning from the auxiliary radio mode to a main radio mode for a given wireless link. For example, the wireless communication device may indicate a message format for the auxiliary radio mode. The indicated message format may be associated with a particular PPDU format (such as non-HT) or a supported data rate (such as ≤24 Mbps).

In some examples, the wireless communication device may indicate transition delays corresponding to time durations associated with switching from the auxiliary mode to the main radio mode as well as switching from the main radio mode to the auxiliary radio mode for a wireless link. A second wireless communication device may schedule data communications with the wireless communication device based on the transition delay so that data is not transmitted to the wireless communication device during the transition delay, during which data may be lost. The duration of the transition delay may generally be dependent on whether the auxiliary radio supports Tx/Rx or Rx-only modes of operation. For example, if the auxiliary radio supports Tx/Rx, the auxiliary radio may transmit an acknowledgment message in response to a request to transition to the main radio mode for a wireless link, which may extend the transition delay. Additionally, or alternatively, the duration of the transition delay may depend on whether the main radio is transitioning from a sleep mode or from a different wireless link.

The auxiliary radio may perform additional functions while the wireless communication device communicates with a second wireless communication device via a wireless link using the main radio. The functions that may be performed may generally depend on whether the auxiliary radio supports Tx/Rx or Rx-only modes of operation or whether the wireless communication device is an MLD capable of supporting communications over more than one wireless link. For example, in an Aux-Rx mode, the auxiliary radio of a wireless communication device (such as a non-AP MLD) may monitor or collect channel state (or quality) information or statistics (such as BSS load, interference profiles of neighboring BSSs and multi-NAV multi-primary maintenance) in a passive manner. In an Aux Tx/Rx mode, the auxiliary radio of the non-AP MLD may monitor or collect channel state information or statistics as well as transmit a report to an AP MLD that includes the collected channel state information or statistics without involvement of the main radio. In some examples, while operating in an Aux-Rx mode, a first wireless communication device (such as an AP MLD) may use the auxiliary radio to receive control communications or high-priority or otherwise important data communications from the second wireless communication device (such as another AP MLD) using a second wireless link while its main radio uses the first wireless link to perform data transfer. In contrast, in an Aux-Tx/Rx mode, an AP MLD may use the auxiliary radio to both receive and transmit control communications or high-priority or otherwise important data communications. In some examples, while operating in an Aux-Rx mode, a non-AP MLD's auxiliary radio may monitor or scan for potential APs to associate with on alternative wireless channels than the wireless channel on which the non-AP MLD's main radio is still communicating with a previously connected AP. In an Aux-Tx/Rx mode, an MLD may use the auxiliary radio to both scan for and perform association or authentication on other wireless channels.

In some environments, locations, or conditions, a regulatory body may impose a power spectral density (PSD) limit for one or more communication channels or for an entire band (for example, the 6 GHz band). A PSD is a measure of transmit power as a function of a unit bandwidth (such as per 1 MHz). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (for example, duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

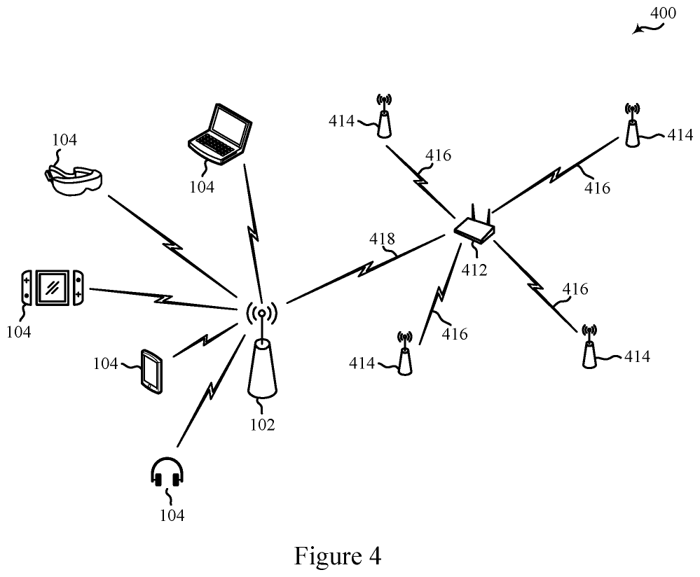

FIG. 4 shows a pictorial diagram of another example wireless communication network 400. According to some aspects, the wireless communication network 400 can be an example of a mesh network, an IoT network, or a sensor network in accordance with one or more of the IEEE 802.11 family of wireless communication protocol standards (including the 802.11ah amendment). The wireless communication network 400 may include multiple wireless communication devices 414, which in some implementations may include APs 102, STAs 104, or both. The wireless communication devices 414 may represent various devices such as display devices (for example, TVs, computer monitors, navigation systems, among others), music or other audio or stereo devices, remote control devices (“remotes”), printers, kitchen or other household appliances, among other examples.

In some examples, the wireless communication devices 414 sense, measure, collect or otherwise obtain and process data and transmit such raw or processed data to an intermediate device 412 for subsequent processing or distribution. Additionally, or alternatively, the intermediate device 412 may transmit control information, digital content (for example, audio or video data), configuration information or other instructions to the wireless communication devices 414. The intermediate device 412 and the wireless communication devices 414 can communicate with one another via wireless communication links 416. In some examples, the wireless communication links 416 include Bluetooth links or other PAN or short-range communication links.

In some examples, the intermediate device 412 also may be configured for wireless communication with other networks such as with a WLAN or a wireless (for example, cellular) wide area network (WWAN), which may, in turn, provide access to external networks including the Internet. For example, the intermediate device 412 may associate and communicate, over a Wi-Fi link 418, with an AP 102 of a wireless communication network 400, which also may serve various STAs 104. In some examples, the intermediate device 412 is an example of a network gateway, for example, an IoT gateway. In such a manner, the intermediate device 412 may serve as an edge network bridge providing a Wi-Fi core backhaul for the IoT network including the wireless communication devices 414. In some examples, the intermediate device 412 can analyze, preprocess and aggregate data received from the wireless communication devices 414 locally at the edge before transmitting it to other devices or external networks via the Wi-Fi link 418. The intermediate device 412 also can provide additional security for the IoT network and the data it transports.

Aspects of transmissions may vary according to a distance between a transmitter (for example, an AP 102 or a STA 104) and a receiver (for example, another AP 102 or STA 104). Wireless communication devices (such as the AP 102 or the STA 104) may generally benefit from having information regarding the location or proximities of the various STAs 104 within the coverage area. In some examples, relevant distances may be determined (for example, calculated or computed) using RTT-based ranging procedures. Additionally, in some examples, APs 102 and STAs 104 may perform ranging operations. Each ranging operation may involve an exchange of fine timing measurement (FTM) frames (such as those defined in the 802.11az amendment to the IEEE family of wireless communication protocol standards) to obtain measurements of RTT transmissions between the wireless communication devices.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and then update the output based on a combination of the input data and the weights.

STAs or APs (for example, a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QoS) load/requirements, or a history of bad/good AP link(s), which may be conveyed in terms of scores or rankings.

In some examples, communication systems may support managed P2P communications, such as P2P scaling. An AP 102 may direct a P2P station to another channel, such as an AP in an ESS or a BSS. Th AP may respond to STA requests soliciting AP assistance by providing a recommended set of channels where the P2P link can operate, a level of protection each recommended channel has (BSS or ESS level), a time period (such as, expressed as a TWT) when the P2P link can be active on the recommended channel, how long the recommended channel will be valid, or any combination thereof (such as, via a channel usage element, a TWT element, a timeout interval element, or the like, of a channel usage response frame action field). In some examples, a channel usage element format may include a usage mode subfield and a channel entry subfield. In some examples, different values of the usage mode definition may indicate different usage modes, such as channel usage aidable BSS, channel usage aidable BSS in which none of the channel usage aidable BSSs that belong to the same ESS operate on the channel identified by the channel entity field, among other examples.

In some examples, wireless communications systems may support P2P extensions. An MU request to send (RTS) TXOP sharing (TXS) (such as, mode 2) may allow an AP 102 to share a TXOP with a non-AP STA that could be used for P2P purposes. The non-AP STA may be a soft AP which may schedule clients through the trigger frame. For instance, after the MU RTS TXS at the AP 102, a soft AP may transmit a CTS and a trigger (triggering one or more other devices), and the other device may transmit data (such as QoS data).

Some wireless communications may support or include a broadcast TWT recommendation field. A broadcast TWT parameter set field format may include a restricted TWT traffic information field. The broadcast TWT parameter set field may include a TWT request field, a TWT setup command field, a trigger field, a last broadcast parameter set, a flow type field, a broadcast TWT recommendation field, a TWT wake interval exponent field, a reserved or aligned field, or any combination thereof. IN some examples, the broadcast TWT recommendation field value may indicate a description, such as corresponding broadcast TWT SPs referred to as an R-TWT SP, or the like. The broadcast TWT information subfield format may include a restricted TWT traffic information present subfield, a reserved or restricted TWT schedule information subfield, a broadcast TWT identifier subfield, a broadcast TWT persistence subfield, or any combination thereof.

In some examples, a TWT setup frame may include one or more action field. For example, in a TWT setup frame with a TWT request field that is set to 1, the dialog token field may be set to a nonzero value selected by the transmitting STA to identify the request or response transaction. In a TWT setup frame with a TWT request field set to 0 that is sent in response to a TWT setup frame with a TWT request field that is equal to 1, the dialog token field may be set to the value copied from a corresponding received TWT setup frame with a TWT request field equal to 1. In some examples, the TWT setup frame may include on TWT element, except if used for establishment of a TWT agreement with a range of TWT parameter values, in which case an additional TWT element may be present.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as APs 102 and STAs 104) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (for example, some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

In some examples, an AI/ML model may be used for spatial reuse (SR) techniques and determinations. For example, a wireless communication device may exchange signaling to ascertain inputs to an AI/ML model and utilize an output of the AI/ML model to perform wireless communications in accordance with a SR procedure to improve the effectiveness of the SR procedure. For example, by using an AI/ML model (and in some aspects, shared observations and measurements from other devices as inputs to the AI/ML model), a transmitting device may more effectively generate SR parameters supporting SR transmissions, resulting in more effective use of available system resources, improved throughput, improved reliability, decreased latency, and better user experience. For example, a STA, an AP, or both, may use an AI/ML model to obtain one or more SR parameters, such as an overlapping basic service set (OBSS) preamble detection (PD) value, or a threshold of detected interference below which the device may transmit at a lower transmit power.

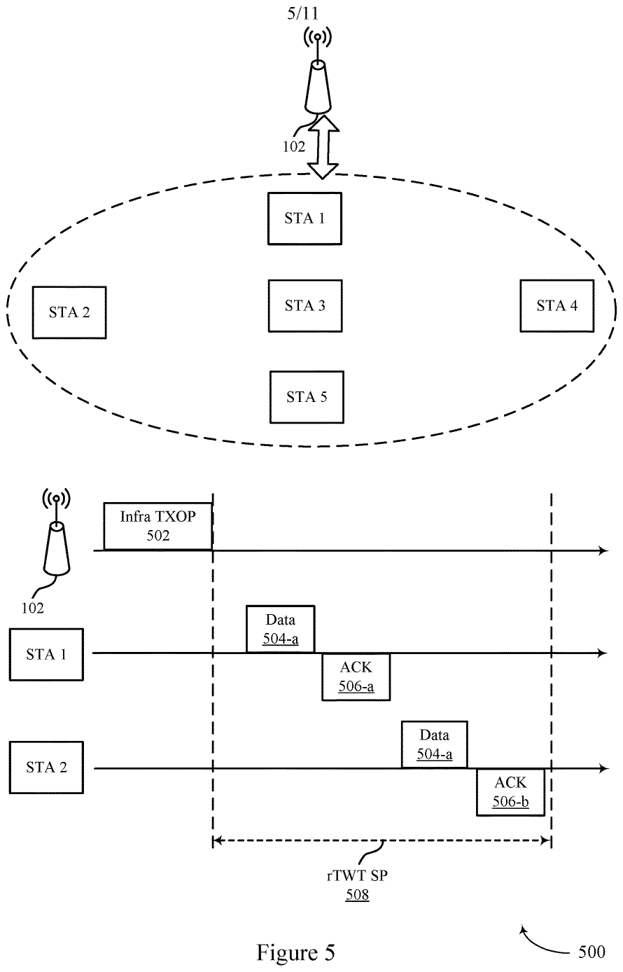

FIG. 5 shows an example of a signaling diagram 500 that supports managing P2P groups. The signaling diagram 500 may implement, or may be implemented by, aspects of FIGS. 1-4. For example, the signaling diagram 500 may include an AP 102, and one or more STAs (e.g., the STA 1, the STA 2, the STA 3, the STA 4, and the STA 5, which may be examples of a STA 104), which may be examples of corresponding devices described with reference to FIGS. 1-5.

Some wireless communications systems may support P2P communications between STAs (such as, clients). In some examples, devices may support frequency domain P2P management. In such examples, one or more channels may be allocated for infrastructure AP deployment, and a channel may be allocated dedicated channel for P2P communications. In such examples, an AP 102 may direct one or more P2P STAs to another channel (such as, an off-channel) for P2P operations.

In some examples, wireless communications may be performed in accordance with time domain P2P management. For example, a P2P TXOP may be allocated for P2P communications. In such examples, a STA may manage communications by other STAs in a P2P group during the TXOP. However, one STA managing communications with other P2P stations during a P2P TXP, or allocating a channel for P2P communications, may be inefficient. For instance, one or more STAs of a P2P group may have a small amount of data or no data at all to communicate during a TXOP, or via a dedicated channel. In such examples, resources of the TXOP or the dedicated channel may remain unutilized, resulting in less efficient use of available system resources, decreased throughput, increased delays and latency, and decreased user experience.

Some wireless techniques may include group P2P management, in accordance with techniques described herein. For example, in accordance with techniques described herein, on-going TXOPs may end prior to the beginning of an rTWT SP. During the rTWT SP, P2P clients may transmit signaling to each other.

According to techniques described herein, the AP 102 may perform wireless communications during infrastructure TXOP 502. The AP 102 may be associated with one or more clients (such as, the STA 1, the STA 2, the STA 3, the STA 4, and the STA 5). One or more of the associated STAs may request rTWT schedule setup by the AP 102. If more clients request the same schedule, then the AP 102 may allocate overlapping rTWT SPs 508. To support aware-based P2P communications, multiple clients following a single schedule may be likely to request overlapping schedules from the AP 102.

The AP 102 may allocate the rTWT schedule (such as, indicating the rTWT SP 508 for the P2P group of STAs). All rTWT supporting clients may end TXOPs (e.g., such as the infrastructure TXOP 502) prior to the beginning of the rTWT SP 508. STAs of a P2P group may perform wireless communications during the rTWT SP 508. For example, of the clients served by the AP 102 (such as, the STA 1, the STA 2, the STA 3, and the STA 4), may request rTWT SP schedule setup by the AP 102. As described herein, the STA 104 may transmit a message indicating the rTWT SP schedule. The STA 1, the STA 2, the STA 3, and the STA 4 may communicate P2P signaling during the rTWT SP 508. For example, the STA 1 may transmit data 504-a (such as, QoS data to the STA 4), and may receive an ACK 506-a (such as, from the STA 4). The STA 2 may transmit data 504-b (such as, QoS data to the STA 2), and may receive an ACK 506-b (such as, from the STA 3). The STA 5 may not be part of the group of STAs, and may not request the rTWT schedule setup. In such examples, the STA 5 may refrain from contending for access during, or may stop a TXOP prior to, the rTWT SP 508.

Neighboring APs 102 (such as, APs 102 that support critical target wait time (CrTWT)) may also announce the schedule to respective BSSs (such as, to limit attempts by neighboring STAs of neighboring BSSs from attempting to access the channel during the rTWT SP 508). Because the rTWT SP 508 schedule is defined upon request (such as, instead of regularly allocated full TXOPs or channels), the rTWT SP 508 may be more efficiently allocated and utilized when there is data to be communicated, resulting in more efficient use of available system resources. Additionally, when communication by the STAs of the P2P group during the rTWT SP 508 are completed, it is possible that other STAs may also be able to access the channel. For example, other clients may not be precluded from contending for access. However, in some examples, a relaxed Arbitration Inter-Frame Space Number (AIFSN) may provide a higher likelihood of accessing the channel to STAs of the P2P group that requests the rTWT SP 508 (such as, in comparison with other STAs that are not part of the P2P group).

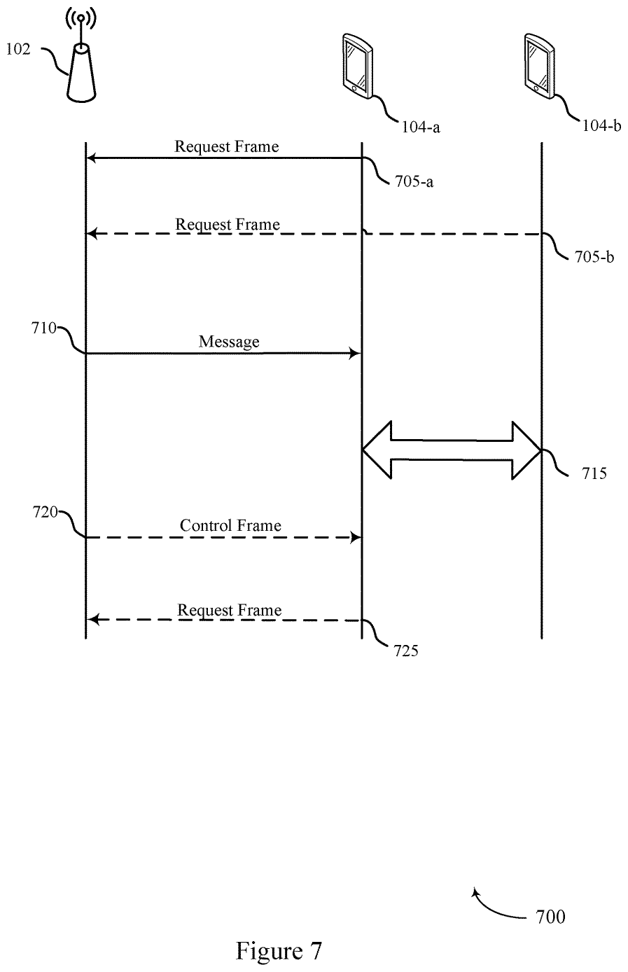

As described in additional detail with reference to FIG. 7, the signaling diagram 500 may support a signaling framework for group P2P. Such a signaling frame work may include signaling for setup or teardown of the rTWT SP 508. In some examples, the signaling framework may include a setup frame transmitted by one or more STAs (such as, a setup frame), and a message (such as a broadcast message) transmitted by the AP 102 indicating the rTWT SP schedule.

For example, to request an rTWT SP schedule, a client may transmit a setup frame (such as, a TWT setup frame) proposing (or requesting) a group P2P schedule. A TWT setup frame may be extended to indicate a request for group P2P (such as, a value or content of the setup frame may indicate that the request is specifically for group P2P communications). In some examples, the setup frame may include a UHR frame which includes a field in a frame format to indicate one or more types of TWT. For instance, the frame format field of the UHR frame may indicate a P2P R-TWT format, which may indicate that the requested rTWT SP is for P2P communications. In some examples, a TWT information extension element may be included in the setup frame. The TWT information extension element may carry a field to indicate one or more types of TWT, such as a P2P R-TWT type. In some examples, the field of the information extension element may also include a list or a bitmap of B-TWT identifiers reported in the TWT element, such that each request is clarified to correspond to a P2P rTWT. The TWT information Extension element may be carried in a beacon frame and may identify the broadcast TWT identifiers that correspond to the group P2P communications. In some examples, a TWT element of the setup frame may include a traffic information control field. Bits of the traffic information control field (such as, bits from a downlink TID bitmap valid field, an uplink TID bitmap valid field, or reserved bits) may be utilized to indicate that the request is for group P2P communications.

In some examples, a STA may request a persistence setting for the group P2P rTWT SP 508 (such as, in terms of target beacon transmission times (TBTTs)). In such examples, a TWT element of the setup frame may convey such a persistence value. If such a persistence value is included in the TWT setup frame, then the AP may announce a greater or equal value of persistence in the message indicating the rTWT schedule.

In some examples, one or more (such as, additional) parameters of the P2P rTWT schedule may be modified, such as a target wake time indicating the start time of the SP, a nominal threshold (such as, minimum) TWT wake Duration indicating the duration of each SP, a TWT wake interval mantissa and a TWT wake interval exponent that characterize the wake interval, among other examples.

Any such parameters (or other parameters) of the rTWT schedule may be requested to be updated or changed by any STA.

In some examples, as described herein, a STA may transmit a request (such as, via a setup frame) to join an existing schedule. For instance, the STA 5 may transmit a setup frame (such as a TWT setup frame) indicating the broadcast TWT identifier of a desired P2P rTWT schedule.

In some examples, as described herein, a STA may transmit a request (such as, via a setup frame) to update (such as, extend or modify) an existing schedule. For instance, the STA 1 may transmit a setup frame (such as, a TWT setup frame) indicating a broadcast TWT ID of a desired or requested P2P rTWT schedule. In such examples, the setup frame may include a recommendation of parameters of a desired or requested P2P rTWT schedule.

In some examples, as described herein, a STA may transmit a request (such as, via a setup frame) to tear down an existing schedule for group P2P TWT SPs. For example, the STA 1 may transmit an indication that the STA 1 is no longer participating in the rTWT SP 508. The AP 102 may then determine whether to tear down the existing schedule (such as, for the STA 1, or for the whole group). The AP 102 may indicate whether it will tear down the existing schedule via a persistence countdown procedure.

The AP 102 may receive the setup frame (such as, a TWT setup frame requesting a P2P rTWT schedule), and may transmit a message indicating the requested rTWT schedule. For example, the AP may transmit a beacon, or an announcement message, among other examples, indicating the rTWT SP 508 and indicating that the rTWT SP 508 is for group P2P communications. For example, the AP 102 may announce an existing schedule. IN such examples, the AP 102 may announce the existence of a group P2P TWT SP 508 using a beacon. In such examples, the AP 102 may include a TWT element with one or more restricted TWT parameter sets in the beacon message. The AP 102 may flag that the restricted TWT parameter sets are for P2P communications. For instance, the AP 102 may utilize a defined value of a broadcast TWT recommendation field. For instance, the value may be set to an integer (such as, 5) indicating a P2P rTWT schedule. Such a value may be interpreted at least by UHR STAs. In some examples, the AP 102 may flag that the restricted TWT parameter set is for P2P communications using an enhanced TWT information Extension element that carries the broadcast TWT ID of a scheduled reported in the TWT element. The enhanced TWT information Extension element may be enhanced with an R-TWT type (such as, P2P R-TWT SP). Such an indication may flag the schedule reported in the beacon as being for group P2P communications, and may be compatible with various types of STAs (such as, legacy STAs, UHR STAs, EHT STAs, and the like). In some examples, the AP 102 may flag the restricted TWT parameter sets as being for P2P communications by using an enhanced TWT information Extension element that carries a list of B-TWT identifiers for TWT schedules carried in a beacon frame, and a qualifier for the list of B-TWT identifiers. One of the values of the qualifier may indicate that P2P communications (such as, a P2P R-TWT value).

For example, as described herein, a TWT information Extension element may include one or more fields, such as an element identifier field, a length field, an element identifier extension field, a control field, an a B-TWT information field. The control field may include a B-TWT information present subfield and a reserved subfield. The B-TWT information subfield may include a broadcast TWT identifier subfield, and a reserved subfield. As described herein, one or more aspects of the TWT information Extension element may be utilized to indicate (such as, in the message announcing the rTWT schedule) that the rTWT schedule is for P2P communications. For example, a P2P indicator and an R-TWT indicator may be included in the B-TWT information field (such as, between bits B5 and B7), and the bits may be used jointly. In some examples, a P2P R-TWT field or subfield may be added (such as, to the B-TWT information field). In some examples, a presence bit may be added to the control field of the information Extension element, which may indicate the presence of a field indicating the type of schedule (such as, where one candidate type that can be indicated by the field is a P2P R-TWT type). In some examples, an optional field (such as, a field based on the presence bit indicator) may contain a list of B-TWT identifiers for P2P R-TWTs.

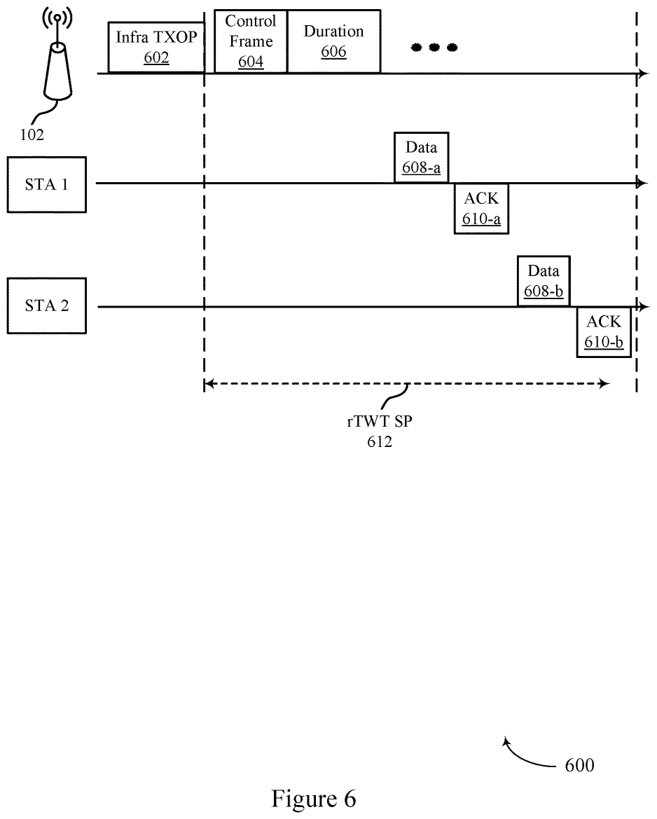

In some examples, one or more STAs may request creation of an exclusive P2P rTWT group, which may be reserved for the STAs in the group. In such examples, the request STAs may include a group identifier, created by a group member, in the setup frame (such as, a TWT setup frame) to create the rTWT schedule. What a STA request to join (or create, update, or modify) a P2P rTWT schedule, the STA may include the group identifier for that schedule in the request message (such as, the setup frame). The group identifier may be included in setup frames (such as, TWT setup frames), and announcement frames (such as the message announcing the rTWT schedule as described herein). Techniques described herein to flag the announced rTWT schedule as being for P2P communications may similarly be utilized to indicate a group identifier that matches a group identifier included in the setup frame. By utilizing the group identifiers, an exclusive P2P rTWT schedule may be defined (such as, where other STAs are not permitted to communicate or attempt to access the channel during the exclusive rTWT SP 508). In some examples, as described in greater detail with reference to FIG. 6, the AP 102 may reserve the channel to accommodate channel access by STAs that are part of the P2P group (e.g., instead of, or in addition to, setting up the exclusive rTWT SP 508 based on the group identifier).

In some examples, during TWT setup signaling, one or more STAs may be capable of indicating QoS characteristics (such as, through SCS, or the like). In such examples, TWT allocation for P2P traffic may be limited to certain QoS levels. For example, the user of SCS during setup may indicate QoS characteristics for traffic flow (such as, with TID) for the P2P rTWT SPs 508. The AP 102 may accept o reject the TWT setup (such as, for one or more requesting STAs) based on QoS characteristics requested by the client.

In some examples, an SCS request/SCS response framework may support techniques based on QoS characteristics. For example, a QoS characteristics element of an SCS request and an SCS response may describe traffic characteristics. The QoS characteristics element may include a direction subfield, which may be set to a value (such as, 2) to indicate that the requested SCS stream being established is for P2P traffic. The QoS characteristic element may contain other parameters for such traffic. More than one QoS Characteristic element may be included in the request if more than one SCS stream is being requested to be established. IN some examples, a TWT request/TWT response framework may be used to indicate the QoS characteristics. The TWT element may negotiate rTWT schedules, and the parameters requested for the rTWT schedules may be indicated. The TWT elements may be included in the TWT request and the TWT response if more than on rTWT schedule is being requested or negotiated. IN some examples, the requesting STA (and in some examples, the responding AP) may ensure that there is alignment of certain parameters with in the QoS characteristics and the TWT elements that pertain to similar requests or characteristics (such as, wake intervals, durations, whether triggered operations are required, among other examples).

In some examples, the QoS characteristics may be indicated via an element in a TWT request and a TWT response, along with other TWT elements. Such signaling of QoS characteristics may avoid using two separate procedures to request the rTWT SP 508 and convey the QoS characteristics. IN some examples, the TWT elements and the QoS characteristics may be performed by ordering of elements to determine a correlation between the schedules (such as, the TWT elements precede the first QoS characteristics if present, when related to the same request or the same stream), or based on a matching of the of the SCID and the TID/UP field of the QoS characteristics elements and the TWT element of downlink and uplink TID bitmaps.

In the case of SCS setup to indicate QoS characteristics for a traffic flow (such as, with a TID) for the P2P rTWT SPs, the AP 102 may accept or reject the TWT setup based on the QoS characteristics requested by the client.

FIG. 6 shows an example of a signaling diagram 600 that supports managing P2P groups. The signaling diagram 600 may implement, or may be implemented by, aspects of FIGS. 1-5. For example, the signaling diagram 600 may include an AP 102, and one or more STAs (e.g., the STA 1, the STA 2, the STA 3, and the STA 4, which may be examples of a STA 104), which may be examples of corresponding devices described with reference to FIGS. 1-5.

In some examples, the signaling diagram 600 may support a protection mechanism for group P2P traffic within the rTWT SP 612. One or more STAs (such as, the STA 1, the STA 2, the STA 3, and the STA 4) may request (such as, via a setup frame) an rTWT schedule. The AP 102 may transmit a message (such as, a beacon) indicating the rTWT SP 612. The AP 102, and one or more clients, may stop one or more TXOPs (such as, the infrastructure TXOP 602) prior to the rTWT SP 612. During the rTWT SP 612, the STA 1 may transmit data 608-a (for example, to the STA 3) and may receive an ACK 610-a. The STA 2 may transmit data 608-b (for example, to the STA 4) and may receive an ACK 610-b).

In some examples, to facilitate communication by the P2P STAs (such as, to minimize the likelihood of other devices accessing the channel during the rTWT SP 612), the AP 102 may reserve the medium by sending a control frame 604 (such as a clear-to-send (CTS) self control frame). The control frame 604 may reserve the channel during the rTWT SP 612 for a duration, such as the duration 606. In some examples, the control frame 604 may set a NAV for all STAs except the group P2P STAs (such as, the STAs that requested the rTWT SP 612).

In some examples, a media access control (MAC) address may be allocated for (such as, reserved by one or more standards documents) P2P communications. In some examples, a group identifier may be used in the setup phase (such as, in a setup frame, such as a TWT setup frame, as described with reference to FIG. 5). In the message transmitted by the AP 102 (such as, a TWT setup response frame, an announcement message, a beacon, or the like), the allocated MAC address may be provided (indicating that the announced rTWT SP 612 is for group P2P communications for the requesting P2P group of STAs). IN some examples, P2P devices may ignore the NAV that is set by the dedicated MAC address, and those STAs may be permitted to access the medium during the r TWT SP 612 (but other STAs may not be permitted to access the medium during at least a portion of the rTWT SP 612 in accordance with the control frame 604). In some examples, all groups may be treated equally, in which case no separate NAV settings may be applied for different groups.

In some examples, the AP 102 may reserve the medium for just enough time to allow an initial (such as, first) P2P access (such as, by the STA 1). The Aps 102 may not protect the entire rTWT SP 612 (which may cause medium under-utilization if there is not sufficient P2P traffic to fill the rTWT SP 612). Thus, the duration 606 may be long enough for a first STA (such as, the STA 1) to access the medium and initiate P2P communications. In some examples, the duration 606 may span some or all of the duration of the rTWT SP 612, but STAs of the P2P group may be permitted to access the medium during the duration 606 within the rTWT SP 612.

FIG. 7 shows an example of a process flow 700 that supports managing P2P groups. The process flow 700 may implement, or be implemented by, aspects of FIGS. 1 through 6. For example, the process flow 700 may include an AP 102, and one or more STAs 104 (such as, the STA 104-a and the STA 104-b), which may be examples of corresponding devices described with reference to FIGS. 1-6.

At 705, one or more STAs may transmit one or more request frames (for example, at 705-a, the STA 104-a may transmit a first request frame, and at 705-b, the STA 104-b may transmit a second request frame). Each request frame may include a request for an rTWT SP for P2P communications with one or more sets of STAs 104. The one or more one sets of STAs may include one or more pair of STAs. When setup of a rTWT schedule consists of or can be used by more than a pair of devices (such as, three or more devices, or multiple pairs of devices), then the identifiers described herein may refer to a group identifier. If the identifier applies to a pair of UEs, then the identifier may be referred to as a P2P identifier, or as a group identifier, session identifier, rTWT identifier, or the like. The request frame may be an example of a TWT request frame, or the like.

The setup frame may include an indication that the request is for the group P2P communications. The indication in the setup frame that the request is for the P2P communications may be a field in the setup frame (such as, a UHR frame, or a TWT setup frame) that indicates a type of TWT corresponding to the rTWT SP for P2P communications. The indication may include a field in an information Extension element (such as, a TWT information Extension element) indicating a type of TWT corresponding to the rTWT SP for P2P communications. In some examples, the indication may include a recommendation field (such as, a broadcast TWT recommendation field) of an information element (such as a TWT information element) including a value corresponding to the rTWT SP for P2P communications. In some examples, the indication may be a bitmap of a traffic information control field of a TWT information element indicating that the requested rTWT SP is for P2P communications.

The request frame may be an example of a request to initiate or start an rTWT schedule, to join an existing schedule, to create a new schedule, or to update (such as, extend or modify) an existing schedule.

At 710, the AP 102 may transmit (such as, broadcast) a message. The message may indicate a schedule for the rTWT SP corresponding to the one or more sets of STAs 104. The message may be a TWT response frame (such as, responsive to the TWT request frame), a beacon, an announcement message, or the like.

The message may include a TWT element carried by a beacon message. The TWT element may include one or more restricted TWT parameter sets including at least one restricted TWT parameter set corresponding to the P2P communications. The beacon message may also include an indication (e.g., in the TWT information Extension element or the TWT element, among other examples) that the one or more restricted TWT parameter sets correspond to the group P2P communications. In some examples the indication may include a value of a broadcast TWT field within the one or more restricted TWT parameter sets that corresponds to the group P2P communications. In some examples the indication includes one or more TWT identifiers (such as, broadcast TWT identifiers) carried within an information Extension element (such as a TWT information Extension element) carried by the beacon message. For example, a field in the TWT extension element, for the schedule identified in the TWT extension element by the broadcast TWT identifier, may match the broadcast TWT identifier for corresponding to the same schedule when carried in the TWT element. Each of the one or more TWT identifiers may correspond to an rTWT schedule for P2P communications.

In some examples, at 705-a, the STA 104-a may generate an identifier (such as, a group identifier or a P2P identifier) for the one or more sets (such as, a pair, multiple pairs, or a group) of STAs. The STA 104-a may include the group identifier in the request for the rTWT SP, and the message received at 710 may include the group identifier that was included in the request frame. The group identifier may be included in the message received at 710 may indicate that the rTWT SP is exclusive to the one or more sets of STAs. The group identifier may be carried within a TWT Information Extension element carried within the beacon frame received at 710. IN some examples, the STA 104-a may indicate the group identifier in its setup request frame (such as, carried within the traffic information field by utilizing reserved bits) to identify which schedule the STA 104-a is requesting to join, tear down, extend, or the like.

In some examples, the STAs 104 may transmit a message indicating QoS requirements or thresholds. The QoS information may be included in the request frames transmitted at 705, or may be included in other signaling, (such as, an SCS request or SCS response framework, a TWT request or TWT response framework, or the like). In some examples, the message may be received at 710 based on the QoS information satisfying a threshold (such as, if the QoS requested by or reported by the STA 104-b does not satisfy a threshold, then the rTWT schedule may not be set up, or the STA 104-b may not be included in the group of P2P STAs for the rTWT schedule.

At 715, the STA 104-a and the STA 104-b may perform group (or pair) P2P communications with one or more STAs (such as, with each other, or with one or more additional STAs) during the rTWT SP in accordance with the schedule.

At 720, during the rTWT SP, the AP 102 may transmit a control frame, which may reserve at least a portion of the rTWT SP for the one or more sets of STAs, and may exclude one or more additional STAs from attempting to gain access to the channel or from communicating during the rTWT SP. IN such examples, the STA 104-a may initiate the group P2P communications (such as, may contend for access to the channel) based on having received the control frame. For instance, the control frame may be a CTS self message, and may reserve the medium for at least a portion of the rTWT SP. Due to the control frame, one or more other STAs (such as, outside of the group of STAs) may not be able to access the channel, or may be less likely to successfully contend for access to the channel. The STA 104-a may thus gain access to the channel and send one or more P2P transmissions. In some examples, the control frame may include a MAC address that is allocated for group P2P communications, which may exclude other STAs from accessing the media during the rTWT SP.

In some examples (such as, at 725), the STA 104-a may transmit a frame (such as, a setup frame) including a request to tear down a schedule for the rTWT SP corresponding to the one or more sets of STAs. In some examples, the AP 102 may determine to tear down the schedule, and may transmit a responsive message confirming tear down of the schedule based on the request to tear down the schedule received at 720.

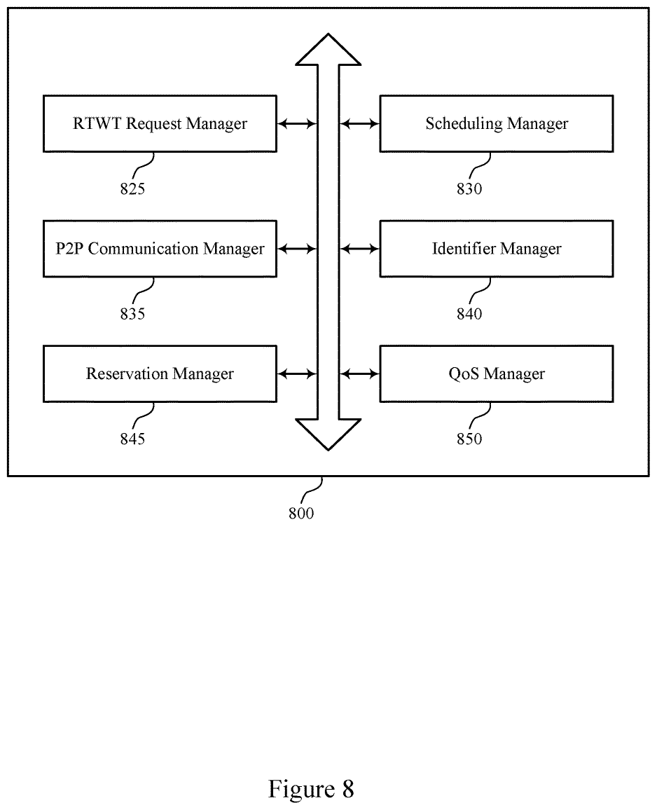

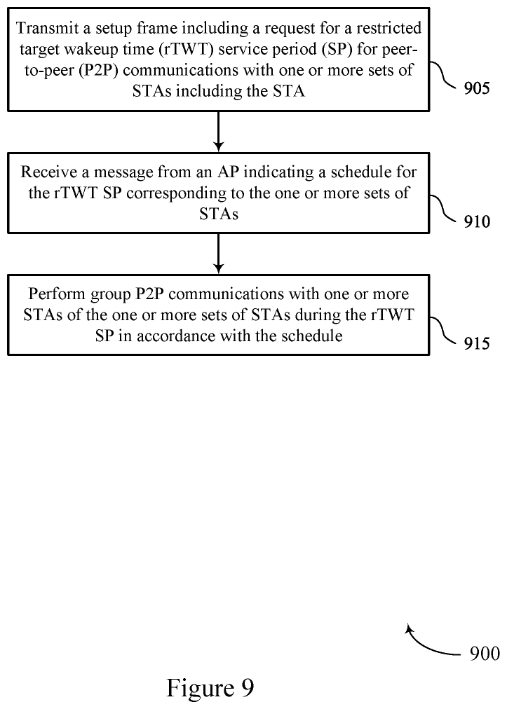

FIG. 8 shows a block diagram of an example wireless communication device 800 that supports managing P2P groups. In some examples, the wireless communication device 800 is configured to perform the processes 900, 1000, and 1100 described with reference to FIGS. 9, 10, and 11, respectively. The wireless communication device 800 may include one or more chips, SoCs, chipsets, packages, components or devices that individually or collectively constitute or include a processing system. The processing system may interface with other components of the wireless communication device 800, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 800 may transmit the information output from the chip. In such an example, the second interface may refer to an interface between the processing system of the chip and a reception component, such that the wireless communication device 800 may receive information that is then passed to the processing system. In some such examples, the first interface also may obtain information, such as from the transmission component, and the second interface also may output information, such as to the reception component.

The processing system of the wireless communication device 800 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 800 can be configurable or configured for use in a STA, such as the STA 104 described with reference to FIG. 1. In some other examples, the wireless communication device 800 can be a STA that includes such a processing system and other components including multiple antennas. The wireless communication device 800 is capable of transmitting and receiving wireless communications in the form of, for example, wireless packets. For example, the wireless communication device 800 can be configurable or configured to transmit and receive packets in the form of physical layer PPDUs and MPDUs conforming to one or more of the IEEE 802.11 family of wireless communication protocol standards. In some other examples, the wireless communication device 800 can be configurable or configured to transmit and receive signals and communications conforming to one or more 3GPP specifications including those for 5G NR or 6G. In some examples, the wireless communication device 800 also includes or can be coupled with one or more application processors which may be further coupled with one or more other memories. In some examples, the wireless communication device 800 further includes a user interface (UI) (such as a touchscreen or keypad) and a display, which may be integrated with the UI to form a touchscreen display that is coupled with the processing system. In some examples, the wireless communication device 800 may further include one or more sensors such as, for example, one or more inertial sensors, accelerometers, temperature sensors, pressure sensors, or altitude sensors, that are coupled with the processing system.

The wireless communication device 800 includes a rTWT request manager 825, a scheduling manager 830, a P2P communication manager 835, an identifier manager 840, a reservation manager 845, and a QoS manager 850. Portions of one or more of the rTWT request manager 825, the scheduling manager 830, the P2P communication manager 835, the identifier manager 840, the reservation manager 845, and the QoS manager 850 may be implemented at least in part in hardware or firmware. For example, one or more of the rTWT request manager 825, the scheduling manager 830, the P2P communication manager 835, the identifier manager 840, the reservation manager 845, and the QoS manager 850 may be implemented at least in part by at least a processor or a modem. In some examples, portions of one or more of the rTWT request manager 825, the scheduling manager 830, the P2P communication manager 835, the identifier manager 840, the reservation manager 845, and the QoS manager 850 may be implemented at least in part by a processor and software in the form of processor-executable code stored in memory.

The wireless communication device 800 may support wireless communications in accordance with examples as disclosed herein. The rTWT request manager 825 is configurable or configured to transmit a setup frame including a request for a restricted target wakeup time (rTWT) service period (SP) for peer-to-peer (P2P) communications with one or more sets of STAs including the STA. The scheduling manager 830 is configurable or configured to receive a message from an access point (AP) indicating a schedule for the rTWT SP corresponding to the one or more sets of STAs. The P2P communication manager 835 is configurable or configured to perform group P2P communications with one or more STAs of the one or more sets of STAs during the rTWT SP in accordance with the schedule.

In some examples, the rTWT request manager 825 is configurable or configured to include, in the setup frame, an indication that the request is for the group P2P communications.

In some examples, the indication includes a field in the setup frame, the field indicating a type of TWT corresponding to the rTWT SP for P2P communications.

In some examples, the indication includes a field in an information extension element indicating a type of TWT corresponding to the rTWT SP for P2P communications.

In some examples, the indication includes a recommendation field of an information element, the recommendation field including a value corresponding to the rTWT SP for P2P communications.

In some examples, the indication includes a bitmap of a traffic information control field of a TWT information element, the bitmap indicating that the requested rTWT SP is for P2P communications.

In some examples, the setup frame includes a request to join an existing schedule, create a new schedule, or update (such as, extend, or modify) an existing schedule.

In some examples, the rTWT request manager 825 is configurable or configured to transmit a second setup frame including a request to tear down the schedule for the rTWT SP corresponding to the one or more sets of STAs. In some examples, the rTWT request manager 825 is configurable or configured to receive a responsive message confirming tear down of the schedule based on the request to tear down the schedule.

In some examples, the message includes a TWT element carried by a beacon message, the TWT element including one or more restricted TWT parameter sets including at least one restricted TWT parameter set corresponding to the P2P communications, the beacon message further including an indication that the one or more restricted TWT parameter sets correspond to the group P2P communications.

In some examples, the indication includes a value of a broadcast TWT recommendation field within the one or more restricted TWT parameter sets that corresponds to the group P2P communications.

In some examples, the indication includes one or more TWT identifiers carried within an information extension element carried by the beacon message, each of the one or more TWT identifiers corresponding to an rTWT schedule for P2P communications.

In some examples, the identifier manager 840 is configurable or configured to generate a group identifier for the one or more sets of STAs. In some examples, the identifier manager 840 is configurable or configured to include the group identifier in the request for the rTWT SP, where the message includes the group identifier indicating that the rTWT SP is exclusive to the one or more sets of STAs.

In some examples, the group identifier is carried within a TWT information extension element carried within a beacon frame.

In some examples, the identifier manager 840 is configurable or configured to include, in the request, the group identifier, the setup frame including a traffic information field, the group identifier indicating the schedule that the STA is requesting to join, extend, or teardown.

In some examples, the reservation manager 845 is configurable or configured to receive, during the rTWT SP based on receiving the message, a control frame which reserves at least a portion of the rTWT SP for the one or more sets of STAs and excludes one or more additional STAs from communications during the rTWT SP. In some examples, the reservation manager 845 is configurable or configured to initiate the group P2P communications with one or more STAs of the one or more sets of STAs based on receiving the control frame.

In some examples, the control frame includes a clear-to-send (CTS) self message setting a network allocation vector (NAV) for the one or more additional STAs.

In some examples, the control frame includes a media access control (MAC) address allocated for group P2P communications, the MAC address being based on a group identifier corresponding to the one or more sets of STAs.

In some examples, the QoS manager 850 is configurable or configured to include, in the setup frame, an indication of one or more quality of service parameters corresponding to the STA, where receiving the message is based on the one or more quality of service parameters satisfying a threshold.

FIG. 9 shows a flowchart illustrating an example process 900 performable by or at a STA that supports managing P2P groups. The operations of the process 900 may be implemented by a STA or its components as described herein. For example, the process 900 may be performed by a wireless communication device, such as the wireless communication device 800 described with reference to FIG. 8, operating as or within a wireless STA. In some examples, the process 900 may be performed by a wireless STA, such as one of the STAs 104 described with reference to FIG. 1.

In some examples, in 905, the STA may transmit a setup frame including a request for a restricted target wakeup time (rTWT) service period (SP) for peer-to-peer (P2P) communications with one or more sets of STAs including the STA. In some implementations, aspects of the operations of 905 may be performed by a rTWT request manager 825 as described with reference to FIG. 8.

In some examples, in 910, the STA may receive a message from an AP indicating a schedule for the rTWT SP corresponding to the one or more sets of STAs. In some implementations, aspects of the operations of 910 may be performed by a scheduling manager 830 as described with reference to FIG. 8.

In some examples, in 915, the STA may perform group P2P communications with one or more STAs of the one or more sets of STAs during the rTWT SP in accordance with the schedule. In some implementations, aspects of the operations of 915 may be performed by a P2P communication manager 835 as described with reference to FIG. 8.

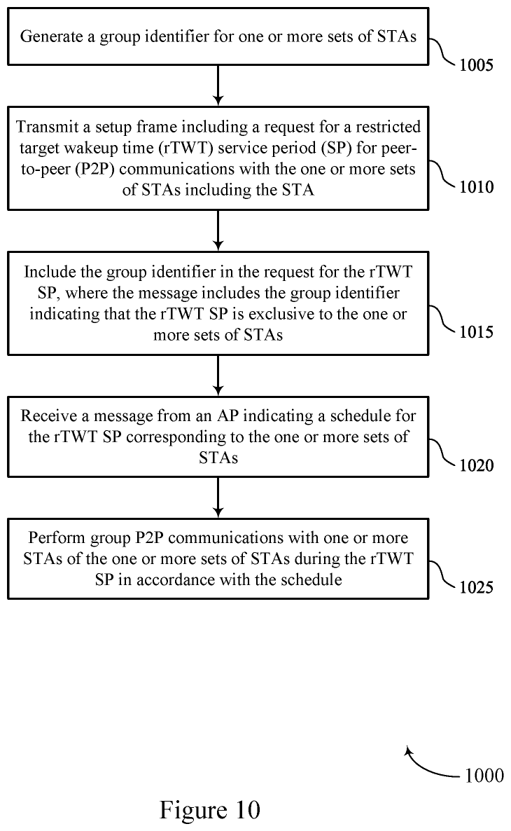

FIG. 10 shows a flowchart illustrating an example process 1000 performable by or at a STA that supports managing P2P groups. The operations of the process 1000 may be implemented by a STA or its components as described herein. For example, the process 1000 may be performed by a wireless communication device, such as the wireless communication device 800 described with reference to FIG. 8, operating as or within a wireless STA. In some examples, the process 1000 may be performed by a wireless STA, such as one of the STAs 104 described with reference to FIG. 1.

In some examples, in 1005, the STA may generate a group identifier for a one or more sets of STAs. In some implementations, aspects of the operations of 1005 may be performed by an identifier manager 840 as described with reference to FIG. 8.

In some examples, in 1010, the STA may transmit a setup frame including a request for a restricted target wakeup time (rTWT) service period (SP) for peer-to-peer (P2P) communications with the one or more sets of STAs including the STA. In some implementations, aspects of the operations of 1010 may be performed by a rTWT request manager 825 as described with reference to FIG. 8.

In some examples, in 1015, the STA may include the group identifier in the request for the rTWT SP, where the message includes the group identifier indicating that the rTWT SP is exclusive to the one or more sets of STAs. In some implementations, aspects of the operations of 1015 may be performed by an identifier manager 840 as described with reference to FIG. 8.

In some examples, in 1020, the STA may receive a message from an AP indicating a schedule for the rTWT SP corresponding to the one or more sets of STAs. In some implementations, aspects of the operations of 1020 may be performed by a scheduling manager 830 as described with reference to FIG. 8.

In some examples, in 1025, the STA may perform group P2P communications with one or more STAs of the one or more sets of STAs during the rTWT SP in accordance with the schedule. In some implementations, aspects of the operations of 1025 may be performed by a P2P communication manager 835 as described with reference to FIG. 8.

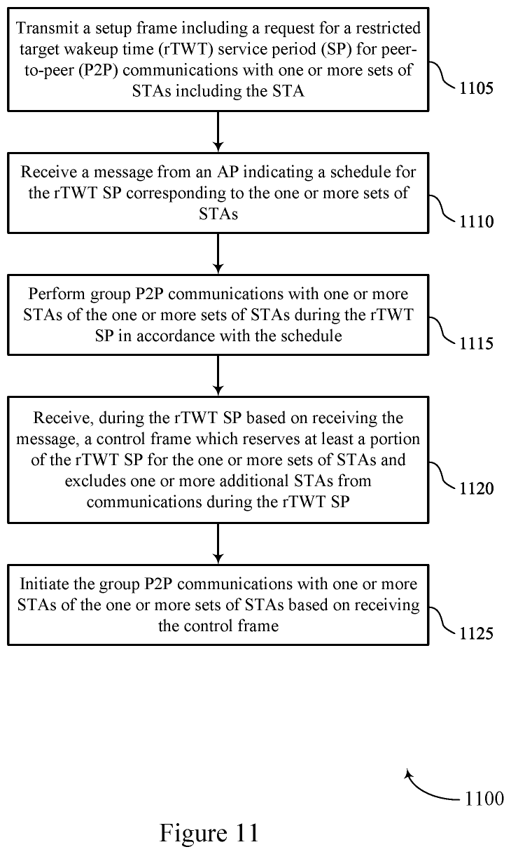

FIG. 11 shows a flowchart illustrating an example process 1100 performable by or at a STA that supports managing P2P groups. The operations of the process 1100 may be implemented by a STA or its components as described herein. For example, the process 1100 may be performed by a wireless communication device, such as the wireless communication device 800 described with reference to FIG. 8, operating as or within a wireless STA. In some examples, the process 1100 may be performed by a wireless STA, such as one of the STAs 104 described with reference to FIG. 1.

In some examples, in 1105, the STA may transmit a setup frame including a request for a restricted target wakeup time (rTWT) service period (SP) for peer-to-peer (P2P) communications with one or more sets of STAs including the STA. In some implementations, aspects of the operations of 1105 may be performed by a rTWT request manager 825 as described with reference to FIG. 8.

In some examples, in 1110, the STA may receive a message from an AP indicating a schedule for the rTWT SP corresponding to the one or more sets of STAs. In some implementations, aspects of the operations of 1110 may be performed by a scheduling manager 830 as described with reference to FIG. 8.

In some examples, in 1115, the STA may perform group P2P communications with one or more STAs of the one or more sets of STAs during the rTWT SP in accordance with the schedule. In some implementations, aspects of the operations of 1115 may be performed by a P2P communication manager 835 as described with reference to FIG. 8.

In some examples, in 1120, the STA may receive, during the rTWT SP based on receiving the message, a control frame which reserves at least a portion of the rTWT SP for the one or more sets of STAs and excludes one or more additional STAs from communications during the rTWT SP. In some implementations, aspects of the operations of 1120 may be performed by a reservation manager 845 as described with reference to FIG. 8.

In some examples, in 1125, the STA may initiate the group P2P communications with one or more STAs of the one or more sets of STAs based on receiving the control frame. In some implementations, aspects of the operations of 1125 may be performed by a reservation manager 845 as described with reference to FIG. 8.

Implementation examples are described in the following numbered clauses:

The following provides an overview of aspects of the present disclosure:

Aspect 1: A method for wireless communications at a STA, comprising: transmitting a setup frame comprising a request for a restricted target wakeup time (rTWT) service period (SP) for peer-to-peer (P2P) communications with one or more sets of STAs comprising the STA; receiving a message from an AP indicating a schedule for the rTWT SP corresponding to the one or more sets of STAs; and performing group P2P communications with one or more STAs of the one or more sets of STAs during the rTWT SP in accordance with the schedule.

Aspect 2: The method of aspect 1, further comprising: including, in the setup frame, an indication that the request is for the group P2P communications.

Aspect 3: The method of aspect 2, wherein the indication comprises a field in the setup frame, the field indicating a type of TWT corresponding to the rTWT SP for P2P communications.

Aspect 4: The method of any of aspects 2 through 3, wherein the indication comprises a field in an information extension element indicating a type of TWT corresponding to the rTWT SP for P2P communications.

Aspect 5: The method of any of aspects 2 through 4, wherein the indication comprises a recommendation field of an information element, the recommendation field comprising a value corresponding to the rTWT SP for P2P communications.

Aspect 6: The method of any of aspects 2 through 5, wherein the indication comprises a bitmap of a traffic information control field of a TWT information element, the bitmap indicating the requested rTWT SP for P2P communications.

Aspect 7: The method of any of aspects 1 through 6, wherein the setup frame comprises a request to join an existing schedule, create a new schedule, or update an existing schedule.

Aspect 8: The method of any of aspects 1 through 7, further comprising: transmitting a second setup frame comprising a request to tear down the schedule for the rTWT SP corresponding to the one or more sets of STAs; and receiving a responsive message confirming tear down of the schedule based at least in part on the request to tear down the schedule.

Aspect 9: The method of any of aspects 1 through 8, wherein the message comprises a TWT element carried by a beacon message, the TWT element comprising one or more restricted TWT parameter sets comprising at least one restricted TWT parameter set corresponding to the P2P communications, the beacon message further comprising an indication that the one or more restricted TWT parameter sets correspond to the group P2P communications.

Aspect 10: The method of aspect 9, wherein the indication comprises a value of a broadcast TWT recommendation field within the one or more restricted TWT parameter sets that corresponds to the group P2P communications.

Aspect 11: The method of any of aspects 9 through 10, wherein the indication comprises one or more TWT identifiers carried within an information extension element carried by the beacon message, each of the one or more TWT identifiers corresponding to an rTWT schedule for P2P communications.

Aspect 12: The method of any of aspects 1 through 11, further comprising: generating a group identifier for the one or more sets of STAs; and including the group identifier in the request for the rTWT SP, wherein the message comprises the group identifier indicating that the rTWT SP is exclusive to the one or more sets of STAs.

Aspect 13: The method of aspect 12, wherein the group identifier is carried within a TWT information extension element carried within a beacon frame.

Aspect 14: The method of any of aspects 12 through 13, further comprising: including, in the request, the group identifier, the setup frame comprising a traffic information field, the group identifier indicating the schedule that the STA is requesting to join, extend, or teardown.

Aspect 15: The method of any of aspects 1 through 14, further comprising: receiving, during the rTWT SP based at least in part on receiving the message, a control frame which reserves at least a portion of the rTWT SP for the one or more sets of STAs and excludes one or more additional STAs from communications during the rTWT SP; and initiating the group P2P communications with one or more STAs of the one or more sets of STAs based at least in part on receiving the control frame.

Aspect 16: The method of aspect 15, wherein the control frame comprises a clear-to-send (CTS) self message setting a network allocation vector (NAV) for the one or more additional STAs.

Aspect 17: The method of any of aspects 15 through 16, wherein the control frame comprises a MAC address allocated for group P2P communications, the MAC address being based at least in part on a group identifier corresponding to the one or more sets of STAs.

Aspect 18: The method of any of aspects 1 through 17, further comprising: including, in the setup frame, an indication of one or more quality of service parameters corresponding to the STA, wherein receiving the message is based at least in part on the one or more quality of service parameters satisfying a threshold.

Aspect 19: A STA for wireless communications, comprising a processing system that includes processor circuitry and memory circuitry that stores code, the processing system configured to cause the STA to perform a method of any of aspects 1 through 18.

Aspect 20: A STA for wireless communications, comprising at least one means for performing a method of any of aspects 1 through 18.

Aspect 21: A non-transitory computer-readable medium storing code for wireless communications, the code comprising instructions executable by one or more processors to perform a method of any of aspects 1 through 18.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A station (STA), comprising:
a processing system that includes processor circuitry and memory circuitry that stores code, the processing system configured to cause the STA to:
transmit a setup frame comprising a request for a restricted target wakeup time (rTWT) service period (SP) for peer-to-peer (P2P) communications with one or more sets of STAs comprising the STA;
receive a message from an access point (AP) indicating a schedule for the rTWT SP corresponding to the one or more sets of STAs; and
perform group P2P communications with one or more STAs of the one or more sets of STAs during the rTWT SP in accordance with the schedule.

2. The STA of claim 1, wherein the processing system is further configured to cause the STA to:
include, in the setup frame, an indication that the request is for the group P2P communications.

3. The STA of claim 2, wherein the indication comprises a field in the setup frame, the field indicating a type of TWT corresponding to the rTWT SP for P2P communications.

4. The STA of claim 2, wherein the indication comprises a field in an information extension element indicating a type of TWT corresponding to the rTWT SP for P2P communications.

5. The STA of claim 2, wherein the indication comprises a recommendation field of an information element, the recommendation field comprising a value corresponding to the rTWT SP for P2P communications.

6. The STA of claim 2, wherein the indication comprises a bitmap of a traffic information control field of a TWT information element, the bitmap indicating the requested rTWT SP for P2P communications.

7. The STA of claim 1, wherein the setup frame comprises a request to join an existing schedule, create a new schedule, or update an existing schedule.

8. The STA of claim 1, wherein the processing system is further configured to cause the STA to:
transmit a second setup frame comprising a request to tear down the schedule for the rTWT SP corresponding to the one or more sets of STAs; and
receive a responsive message confirming tear down of the schedule based at least in part on the request to tear down the schedule.

9. The STA of claim 1, wherein the message comprises a TWT element carried by a beacon message, the TWT element comprising one or more restricted TWT parameter sets comprising at least one restricted TWT parameter set corresponding to the P2P communications, the beacon message further comprising an indication that the one or more restricted TWT parameter sets correspond to the group P2P communications.

10. The STA of claim 9, wherein the indication comprises a value of a broadcast TWT recommendation field within the one or more restricted TWT parameter sets that corresponds to the group P2P communications.

11. The STA of claim 9, wherein the indication comprises one or more TWT identifiers carried within an information extension element carried by the beacon message, each of the one or more TWT identifiers corresponding to an rTWT schedule for P2P communications.

12. The STA of claim 1, wherein the processing system is further configured to cause the STA to:
generate a group identifier for the one or more sets of STAs; and
include the group identifier in the request for the rTWT SP, wherein the message comprises the group identifier indicating that the rTWT SP is exclusive to the one or more sets of STAs.

13. The STA of claim 12, wherein the group identifier is carried within a TWT information extension element carried within a beacon frame.

14. The STA of claim 12, wherein the processing system is further configured to cause the STA to:
include, in the request, the group identifier, the setup frame comprising a traffic information field, the group identifier indicating the schedule that the STA is requesting to join, update, or teardown.

15. The STA of claim 1, wherein the processing system is further configured to cause the STA to:
receive, during the rTWT SP based at least in part on receiving the message, a control frame which reserves at least a portion of the rTWT SP for the one or more sets of STAs and excludes one or more additional STAs from communications during the rTWT SP; and
initiate the group P2P communications with one or more STAs of the one or more sets of STAs based at least in part on receiving the control frame.

16. The STA of claim 15, wherein the control frame comprises a clear-to-send (CTS) self message setting a network allocation vector (NAV) for the one or more additional STAs.

17. The STA of claim 15, wherein the control frame comprises a media access control (MAC) address allocated for group P2P communications, the MAC address being based at least in part on a group identifier corresponding to the one or more sets of STAs.

18. The STA of claim 1, wherein the processing system is further configured to cause the STA to:
include, in the setup frame, an indication of one or more quality of service parameters corresponding to the STA, wherein receiving the message is based at least in part on the one or more quality of service parameters satisfying a threshold.

19. A method for wireless communications at a station (STA), comprising:
transmitting a setup frame comprising a request for a restricted target wakeup time (rTWT) service period (SP) for peer-to-peer (P2P) communications with one or more sets of STAs comprising the STA;
receiving a message from an access point (AP) indicating a schedule for the rTWT SP corresponding to the one or more sets of STAs; and
performing group P2P communications with one or more STAs of the one or more sets of STAs during the rTWT SP in accordance with the schedule.

20. A non-transitory computer-readable medium storing code for wireless communications, the code comprising instructions executable by one or more processors to:
transmit a setup frame comprising a request for a restricted target wakeup time (rTWT) service period (SP) for peer-to-peer (P2P) communications with one or more sets of stations (STAs) comprising a STA;
receive a message from an access point (AP) indicating a schedule for the rTWT SP corresponding to the one or more sets of STAs; and
perform group P2P communications with one or more STAs of the one or more sets of STAs during the rTWT SP in accordance with the schedule.
